(19) United States
(12) Patent Application Publication
(10) Pub. No.: US 2006/0027049 A1
(43) Pub. Date: Feb. 9, 2006

(54) Ratcheting wrench

(76) Inventor: Robert L. Arnold, Wrightsville, PA (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 10/914,659

(22) Filed: Aug. 9, 2004

(51) Int. Cl. B25B 13/46

(52) U.S. Cl. 81/60

(57) ABSTRACT

A ratcheting tool includes a body and a ring disposed in the body. The ring defines a plurality of teeth on a circumference of the ring. A pawl is disposed in the body so that the pawl is movable with respect to the ring between a first position, in which the body transmits torque through the pawl in a first rotational direction, and a second position, in which the body rotates relative to the ring in an opposite rotational direction. The pawl defines a plurality of teeth facing the ring and engages a detent located between the pawl, body and ring. The detent urges the pawl between the first and second positions by engaging a portion of the pawl.

### BACKGROUND OF THE INVENTION

1. Field of the Invention

The present invention relates to a ratchet-type box end wrench and, more particularly, to an improved ratcheting box end wrench.

2. Description of the Related Art

Ratcheting tools, for example ratchets and wrenches, often include a generally cylindrical ratchet ring and a pawl that controls the ring's ratcheting direction so that the ring may rotate in one direction but is prevented from rotation in the other. It is known to dispose the pawl so that it engages teeth either on the ring's inner or outer diameter. Examples of ratcheting tools having a sliding pawl engaging the outer diameter of a ratchet ring are provided in U.S. Pat. Nos. 5,636,557 and 6,134,990, the entire disclosure of each of which is incorporated by reference herein.

### SUMMARY OF THE INVENTION

The present invention recognizes and addresses considerations of prior art constructions and methods. In one embodiment of the present invention, a ratcheting tool has a body, a ring rotatably disposed in the body and defining a first plurality of teeth about an outer circumference thereof, a pawl disposed in the body and having a front side that faces the first plurality of ring teeth and that has a second plurality of teeth thereon, and a back side facing away from the ring. The pawl is movable between a first position in which the body imparts rotation to the ring in a first direction and a second position in which the body rotates relative to the ring in a second direction opposite the first direction. The ratcheting wrench further includes a detent disposed in the body and in operative engagement with the pawl, the detent being formed from a flat spring having a first end and an opposite second end, a top edge and a bottom edge that extend between the first end and the opposite second end, and a thickness between a front face and a back face of the flat spring. The detent has a length that is larger than both of the height and the thickness of the flat spring, and the flat spring has at least one bend transverse to the length that bisects the flat spring into a first portion and a second portion. The first spring portion engages the pawl and the second spring portion is intermediate the body and the ring.

In another embodiment, the ratcheting wrench has a body, a ring rotatably disposed in the body and defining a first plurality of teeth about an outer circumference thereof, a pawl disposed in the body and having a front side that faces the first plurality of ring teeth and that has a second plurality of teeth thereon, a back side facing away from the ring, and a projection extending from a portion of the pawl intermediate the pawl front side and the pawl back side. The pawl is movable between a first position in which the body imparts rotation to the ring in a first direction and a second position in which the body rotates relative to the ring in a second direction opposite the first direction. The wrench includes a detent disposed in the body and in operative engagement with the pawl so that the detent biases the pawl into the first or the second positions. The detent has a flat first end in operative engagement with the pawl projection, a curved second end intermediate the body and the ring, and a main body connecting the flat first end and the curved second end, wherein a spring biases the flat first end away from the curved second end.

In yet another embodiment, a wrench has a body, a ring rotatably disposed in the body and defining a first plurality of teeth about an outer circumference thereof, a pawl disposed in the body and having a front side that faces the first plurality of ring teeth and that has a second plurality of teeth thereon, a back side facing away from the ring that defines a recessed area. The pawl is movable between a first position in which the body imparts rotation to the ring in a first direction and a second position in which the body rotates relative to the ring in a second direction opposite the first direction. The wrench includes a detent disposed in the body and in operative engagement with the pawl so that the detent biases the pawl into the first and the second positions. The detent has a first looped portion received by the pawl recessed area, and a second looped portion that is continuous with the first looped portion and of a larger cross-section than the first looped portion, wherein the second larger looped portion is received intermediate the body and the ring.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of a ratcheting box end wrench in accordance with an embodiment of the present invention;

FIG. 2 is an exploded perspective view of the ratcheting box end wrench of FIG. 1;

FIG. 3 is a cross-sectional view of the ratcheting box end wrench of FIG. 1;

FIG. 4 is a cross-sectional view of the ratcheting box end wrench of FIG. 1;

FIG. 5 is a top view of components of a wrench during a design procedure in accordance with an embodiment of the present invention;

FIG. 5A is an enlarged view of a portion of the components shown in FIG. 5;

FIG. 5B is a sectioned view of a pawl for use in the design procedure of FIG. 5;

FIG. 6 is an exploded perspective view of a ratcheting box end wrench in accordance with an embodiment of the present invention;

FIG. 7 is a cross-sectional view of the ratcheting box end wrench of FIG. 6;

FIG. 8A is a partial perspective view of a toothed ring in accordance with an embodiment of the present invention; and

FIG. 8B is a partial perspective view of a pawl in accordance with an embodiment of the present invention;

FIG. 9 is a perspective view of spring in accordance with an embodiment of the present invention;

FIG. 9A is a cross-sectional view of a ratcheting box end wrench including the spring of FIG. 9;

FIG. 10 is a perspective view of spring in accordance with an embodiment of the present invention;

FIG. 10A is a cross-sectional view of a ratcheting box end wrench including the spring of FIG. 9 and the pawl of FIG. 8A.

Repeat use of reference characters in the present specification and drawings is intended to represent same or analogous features or elements of the invention.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

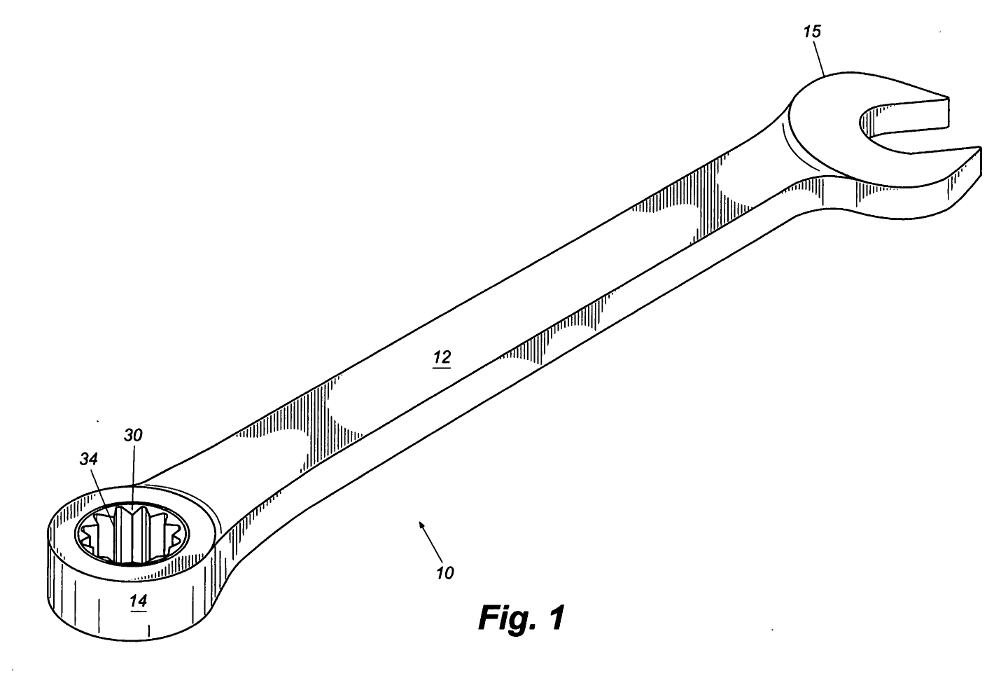

Referring to FIGS. 1 to 4, and in particular to FIG. 1, a ratcheting tool 10 includes a body with a handle 12 and a head 14 extending from one end of the handle. The head and handle may be integrally formed from a material capable of withstanding high shear forces, for example stainless steel, metal alloys, ceramics, or polymers. Handle 12 may be a solid piece and is generally rectangular in shape. The shape and length of handle 12 may vary depending on the application of ratcheting tool 10; for example, handle 12 may be generally cylindrical or polygonal in cross-section. An open end head 15 or box end head (not shown) may be formed on the end of handle 12 opposite from head 14, as should be well understood in the art.

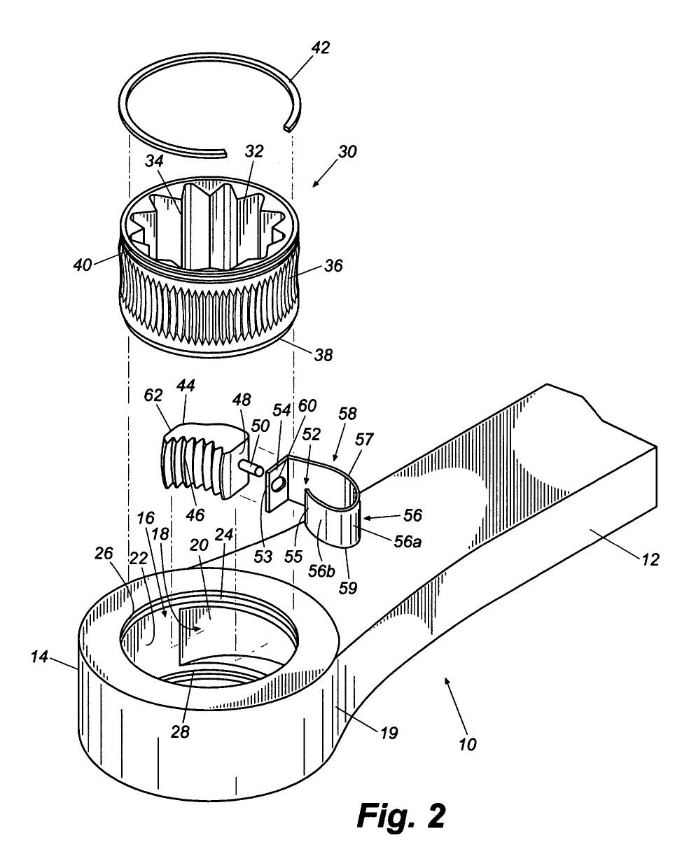

With reference to FIG. 2, head 14 defines a relatively large and generally cylindrically shaped through-hole compartment 16. A wall 22 defining compartment 16 also defines an annular groove 24 proximate its top edge 26 and a flat annular inward extending ledge 28 proximate its bottom edge. A smaller compartment 18 defined in a web portion 19 is intermediate compartment 16 and handle 12, closed above and below and in communication with compartment 16. Compartment 18 is generally wedge shaped and bounded by a curved side wall 20.

Compartment 16 receives an annular toothed ring 30 having an inner surface 32 that is concentric with wall 22. Inner ring surface 32 defines a plurality of aligned keys 34 spaced equiangularly about inner surface 32. Keys 34 extend radially into compartment 16 and are spaced to engage the sides of a bolt, nut, or other work piece. The outer circumference of toothed ring 30 defines a series of teeth 36. Teeth 36 curve inward at their center so that the toothed ring's outer surface defines a concave shape. A bottom side of toothed ring 30 defines an extension portion 38 surrounded by a flat annular shoulder (not shown). Extension portion 38 fits through ledge 28 so that the shoulder sits on ledge 28, thereby retaining toothed ring 30 in the lower axial direction. Extension portion 38 fits through ledge 28 with sufficient clearance so that the ledge secures the toothed ring in the radial direction yet permits the toothed ring to rotate with respect to head 14.

Toothed ring 30 defines an annular groove 40 about its outer surface proximate its upper end. A C-ring 42 is received in groove 40, and an outer surface of the C-ring normally extends slightly outward of the groove. As toothed ring 30 is inserted into compartment 16, C-ring 48 compresses into groove 40 until groove 40 aligns with annular groove 24 in the upper edge of wall 22. C-ring 42 then expands into groove 40, thereby securing toothed ring 30 in the upper axial direction.

A generally wedge-shaped pawl 44 is received in compartment 18 so that the top and bottom surfaces of compartment 18 retain the pawl from above and below. Sufficient clearance is provided between those surfaces and the pawl, however, so that the pawl may easily slide from side to side. Pawl 44 defines a plurality of vertically-aligned teeth 46 in an arc across the pawl's front face that matches the arc of the outer perimeter of toothed ring 30. In the vertical direction, teeth 46 curve outward in a convex shape that corresponds to the concave outer surface of toothed ring 30. A projection 50 extends from a first side 48 of pawl 44.

A spring 52 is received in compartment 18 adjacent pawl 44 and is formed from a generally flat spring material having a first end 53 and an opposite second end 55, which define a length therebetween that is substantially longer than a height between a top edge 57 and a bottom edge 59. Spring 52 defines a first straight end 54 and a curved second end 56 connected by a main body 58. An oblong shaped hole 60 is formed in that first straight end 54 receives pawl projection 50. Spring second end 56 generally contains two portions: a first curved portion 56a for engaging pawl compartment wall 20 and a second semi curved portion 56b received adjacent ring teeth 36. The spring may be formed from any suitable resilient material, including stainless steel, nylon or metal alloys such as beryllium copper. The thickness of the spring material may vary by the wrench size and the amount of spring force required for biasing the pawl during operation of the wrench. In one embodiment, spring 52 is formed from a 0.010-0.012 inch thick stainless steel spring material.

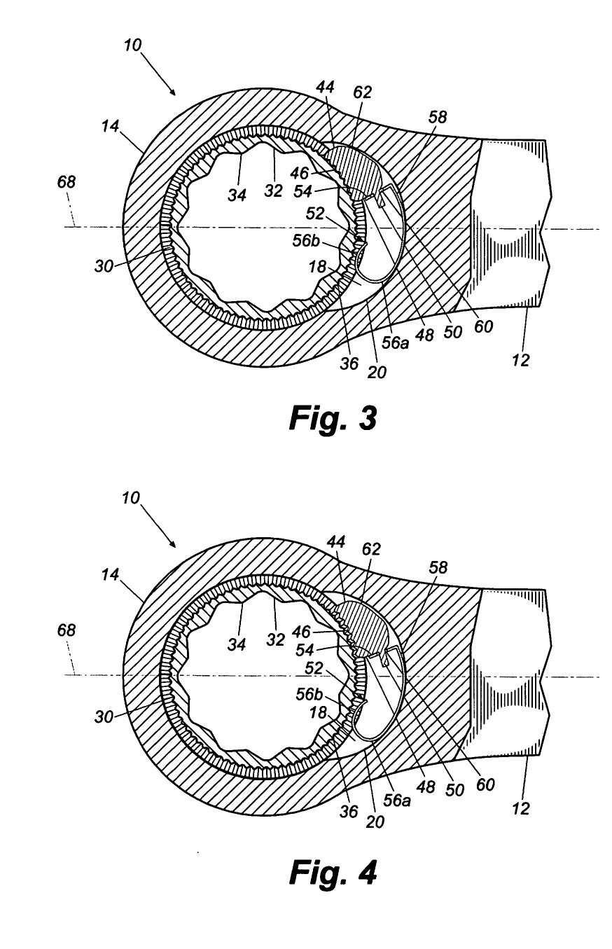

Referring particularly to FIGS. 3 and 4, spring first end 54 is received adjacent to pawl end 48.so that pawl projection 50 is received in spring hole 60. Spring second end 56 is received intermediate toothed ring 30 and pawl compartment wall 20 so that curved portion 56a abuts pawl compartment wall 20 and spring semi curved portion 56b abuts toothed ring 30. In this position, pawl 44 is wedged between toothed ring 30 and pawl compartment wall 20 under minimum tension by spring 52. That is, the spring is sized and shaped to maintain pawl 44 in the wedged position against ring teeth 36.

In operation, pawl 44 may slide over a limited distance in compartment 18 against the bias of spring 52. In the position shown in FIG. 3, pawl 44 is wedged between toothed ring 30 and pawl compartment wall 20. Spring first end 54 engages pawl end 48 so that the spring 52 maintains the pawl in a position at which all of pawl teeth 46 align with and engage ring teeth 36. A second end 62 of pawl 44 abuts pawl compartment wall 20 so that the pawl wedges between the wall and the ring. Thus, if torque is applied to handle 12 in the clockwise direction (as viewed in FIG. 3), pawl compartment wall 20 pushes pawl teeth 46 against ring teeth 36. As a result, the pawl remains wedged between the toothed ring and the compartment's wall, and the force applied from the operator's hand to the pawl through pawl compartment wall 20 is applied in the clockwise direction to a work piece through toothed ring 30.

Alternatively, if an operator applies torque to the handle in the counterclockwise direction (as viewed in FIG. 3), ring teeth 36 apply a clockwise reaction force to pawl teeth 46. If toothed ring 30 remains rotationally fixed to the work piece and the reaction force is reversed, the pawl moves back and down into compartment 18 (as shown in FIG. 4), causing pawl end 48 to push against spring first end 54 against the spring bias of spring 52. This forces spring first end 54 toward spring body 58 against the spring's natural bias so that pawl teeth 46 eventually ride over ring teeth 36. As pawl 44 moves through pawl compartment 18, projection 50 moves across spring hole 60, allowing the pawl to move away from the ring teeth to facilitate the pawl teeth riding over the ring teeth during ratcheting. After the pawl teeth ride over the ring teeth, spring first end 54 once again pushes pawl end 48 back up pawl compartment wall 20 and into the next set of ring teeth. This ratcheting process repeats as the operator continues to rotate handle 12 in the clockwise direction.

To change the operative direction of ratcheting tool 10, the operator flips the wrench 180 degrees about an axis 68 (FIG. 3) so that wrench 10 applies torque in the counterclockwise direction and ratchets in the clockwise direction. In this position, the configuration and operation of the ring, the pawl, and the spring mirror the pawl's operation described above with respect to FIGS. 3 and 4. That is, the tool ratchets and applies torque to a work piece in the same manner but in the opposite direction.

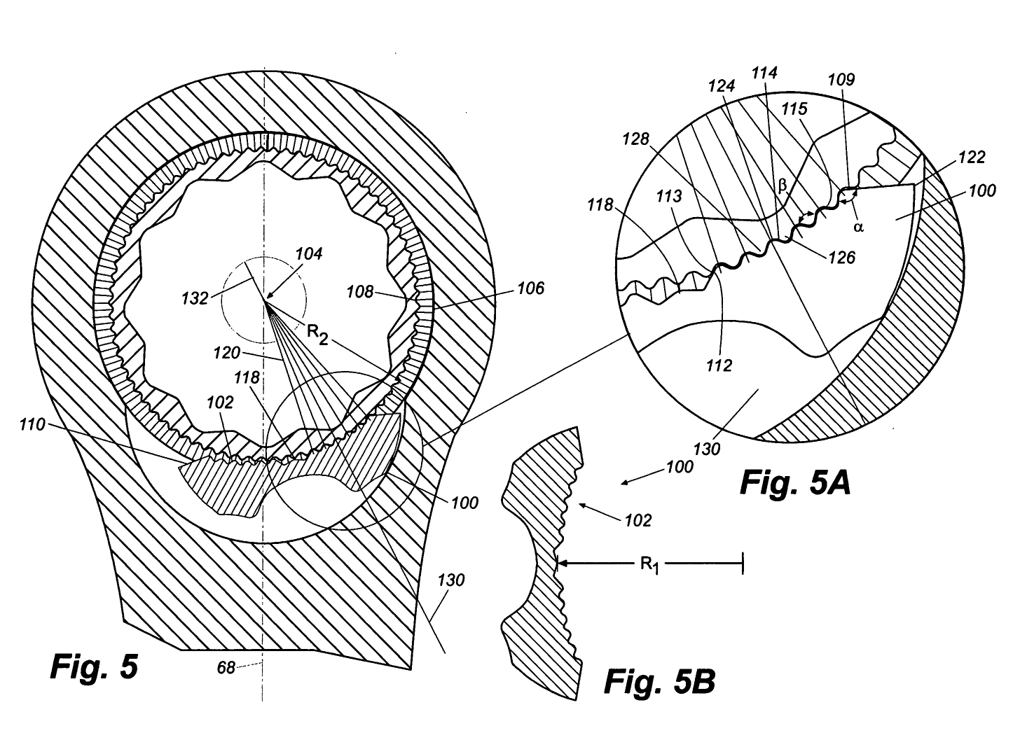

In another embodiment of the ratcheting wrench, the pawl may have a radius that differs from the radius of the toothed ring. That is, the radius of the pawl face can be made slightly larger than the radius of the ring teeth, allowing for a smoother operation of the ring and pawl. One method for manufacturing such a pawl includes the process of manufacturing a pawl for use in a reversible ratcheting wrench (FIG. 5B) having a radius across the pawl teeth that is larger than the radius of the ring teeth and cutting the pawl in half to form two pawls for use in the nonreversible wrench of the present invention. The following paragraphs describe one method of forming such a pawl.

FIGS. 5, 5A and 5B disclose a pawl 100 that defines a plurality of vertically-aligned teeth 102 across the pawl's front face in an arc having a radius denoted by R1 (FIG. 5B). The illustrated pawl is for use in a reversible ratcheting wrench because of the symmetrical pawl teeth about a center point 118. Such a design allows the pawl to be shifted within a pawl pocket to rotationally fix the ring teeth to the head in either a first or second direction.

In the illustrated embodiment, the tips of the teeth are rounded slightly, and radius R1 is measured to the rounded tips of the teeth. The radius R1 is different than a radius R2 (FIG. 5) between the center 104 of toothed ring 106 and the troughs of its teeth 108. Because of manufacturing tolerances, the tips of the pawl teeth and the troughs of the ring teeth vary slightly in the radial direction, as should be understood in this art. Thus, radii R1 and R2 should be understood to lie within the pawl and ring tolerance ranges and are assumed to extend to the mid-points of the respective tolerance range for purposes of this discussion. Furthermore, it should be understood that radii R1 and R2 may be taken at other locations on the ring and the pawl, for example at the tips of the ring teeth and the troughs of the pawl teeth.

As indicated previously, radius R1 of a curve defined by the tips of the pawl teeth is larger than the radius R2 of a curve defined by the troughs of the ring teeth. The ratio of R1 to R2 is preferably within a range of 1:1.08 to 1:1.3. In the example shown in FIGS. 5-5B, the ratio is 1:1.12, where radius R1 equals 0.458 inches. The depth of the ring teeth and the pawl teeth is approximately 0.020 inches.

Preferably, the ring teeth are formed uniformly about the ring's circumference. The depth of each tooth, which may be defined as the distance along a radius of the ring extending between the tooth's tip and an arc connecting the troughs beside the teeth, is the same. The internal angle between the sides of a tooth (the “included” angle) is the same for each tooth, and the angle between sides of adjacent teeth (the “adjacent” angle) is the same for each pair of adjacent teeth.

The dimensions of the pawl teeth, and the ratio between ring radius R2 and pawl radius R1, may be determined by modifying an initial assumption that the pawl teeth will exactly fit the ring teeth. That is, the depths and the included and adjacent angles of the pawl teeth initially match the corresponding dimensions of the ring teeth. Still referring to FIGS. 5-5A, both sides of each pawl tooth are then pivoted (for example, using a computer-aided design (“CAD”) system) toward each other by 1.5 degrees about the tooth's theoretical tip, thereby reducing the tooth's included angle α by approximately 3 degrees. The non-loaded side 109 of each of the three outermost teeth on each side of the pawl is then shaved by 0.003-0.005 inches, and the tips of the teeth are rounded. The degree of rounding increases from the outermost teeth to the pawl center so that the rounded tips define a common radius (within manufacturing tolerances). As will be appreciated, this procedure results in a slightly non-flush engagement between the load-bearing sides 115 of the pawl teeth and opposing load bearing ring tooth sides 113.

Because the pawl radius R1 is larger than the ring radius R2, the included angles α and adjacent angles β of the pawl teeth are not uniform. The variation results from pivoting the pawl teeth's non-load-bearing sides 109 so that the included angle α of each tooth is reduced by a desired amount (preferably one to two degrees) less than the included angle of the ring teeth. This adjustment results in a slight gap between the non-load-bearing ring teeth sides 115 and the non-load-bearing pawl teeth sides 109. The gap reduces or eliminates fluid adhesion (caused by grease or oil in the mechanism) and taper fit between the ring and pawl teeth, thereby facilitating smooth removal of the pawl teeth from the ring teeth during ratcheting and pawl reversal. FIG. 5A illustrates the pawl teeth to one side of a center tooth 118 (FIG. 5). The positions of the teeth on the opposite side of tooth 118 are a mirror image of the illustrated side and are therefore not shown. It should be understood though that the radius of the pawl teeth is uniform from one side of the pawl teeth to the other side.

It should be understood that a ratio of the ring diameter can be used to scale the dimensions of the pawl, ratchet head, and other ratchet components. The ring diameter for determining the ratio is measured across the tips of the ring teeth. When determining the ratio of the pawl radius to the ring radius, radius R1 is measured to the tips of the pawl teeth and R2 is measured to the troughs of the ring teeth as shown in FIG. 5.

The ring/pawl radius ratio may vary among tools of different sizes, but the ratio may also vary among tools of the same size. That is, the particular ratio for a given tool may be selected independently of other tool designs, preferably within a range of 1:1.08 to 1:1.3. A ratio for a particular tool design may be determined by trial and error, but it is believed that the two primary factors determining an appropriate range for the radius ratio are (1) the ring radius and (2) the depth of the teeth on the ring and the pawl. Once these parameters are chosen, a radius ratio may be selected on a CAD system or other graphic means through the method described below.

FIGS. 5 and 5A represent a CAD depiction of ring 106 and pawl 100. The operation of CAD systems should be well understood in this art and is therefore not discussed herein. Initially, the pawl and ring are disposed so that they face one another. The body of the ratchet wrench head is illustrated for purposes of context but is preferably omitted from the CAD drawing. The theoretical (i.e. non-rounded) tip of each pawl tooth lies on a respective line 120 that passes through center 104 of ring 106 and the trough between the opposing ring teeth on the loaded side of the pawl. The included angles α are consistent across all pawl teeth and are the same as the ring teeth adjacent angles. The depth of the pawl teeth is the same as the depth of the ring teeth, and all teeth are as yet not rounded. An initial ring/pawl radius ratio is selected arbitrarily. The adjacent angle β depends on the selected initial radius ratio but is the same for all pawl teeth. If a 1:1 ratio is selected, the pawl's adjacent tooth angle β is the same as the adjacent angle between the ring teeth.

Next, a pivot tooth is selected on one side of the pawl's center tooth 118. Preferably, the pivot tooth is the principal load-bearing tooth. The particular number of load-bearing teeth on either pawl side depends on the density of teeth on the pawl, the design of the back of the pawl and the design of the compartment wall against which the pawl sits. Given a design where these factors are known, the load-bearing teeth may be identified by applying very high loads to a ratchet and observing which teeth are first to shear or by simply assessing the design from experience with prior designs. In the embodiment shown in FIGS. 5 and 5A, the load-bearing teeth are the four outermost teeth inward of pawl end 122, and the pivot tooth is preferably tooth 124—the closest one of these teeth to center tooth 118.

After selecting the pivot tooth, the pawl is moved so that pivot tooth 124 is received in exact alignment with the gap between adjacent ring teeth 126 and 128 on the ring. That is, tooth 124 is fully received in the gap between teeth 126 and 128, and its sides 112 and 114 are flush against the opposing sides of teeth 126 and 128, respectively. If the initial radius ratio is not 1:1, the pivot tooth is the only tooth that fits exactly between its opposing ring teeth. The teeth on either side of the pivot tooth are increasingly misaligned with the gaps between their opposing ring teeth.

The final pawl radius is defined along a radius line 130 that includes center 104 of ring 106 and the non-rounded tip of pivot tooth 124. A point 132 on line 130 is initially defined as the center of curvature of the non-rounded tips of the pawl teeth as originally drawn on the CAD system. That is, point 132 is the origin of the pawl radius, and the pivot tooth defines the point at which an arc defined by the ring radius is tangent to an arc defined by the pawl radius. To determine the final pawl radius (in this instance, the radius to the theoretical tips of the pawl teeth), point 132 is moved along line 130 behind point 104. The adjacent angles β between the pawl teeth change in accordance with the changing pawl radius. The pawl teeth depth and included angles, as well as the alignment of pivot tooth 124 in the gap between its opposing ring teeth, remain fixed. As point 132 moves closer to ring center point 104 along line 130, the pawl radius decreases, and the pawl teeth on either side of pivot tooth 124 move closer into the gaps between the opposing ring teeth. Conversely, the pawl radius increases as point 132 moves away from center point 104, and the pawl teeth on either side of pivot tooth 124 moves away from the ring teeth. Preferably, point 132 is selected so that the non-rounded tip of the outermost tooth 110 (FIG. 5) on the opposite side of center tooth 118 from pivot tooth 124 is within one-half to fully out of the gap between its opposing ring teeth. That is, assume that an arc defined by troughs 108 between the ring teeth is assigned a value of zero and that an arc defined by the ring tooth tips is assigned a value of 1. The tip of pawl tooth 110 preferably is disposed within a range including and between two intermediate arcs located at 0.50 and 1.0.

Once the pawl radius, and therefore the ring/pawl radius ratio, has been determined, the pawl teeth are modified to their operative dimensions. The pawl remains located by the CAD system in the wedged position against the ring as shown in FIG. 5, and the pivot tooth remains in exact alignment with its opposing ring teeth 126 and 128. The non-loaded side 109 of each pawl tooth, including the pivot tooth, is pivoted about the tip of the tooth so that the tooth's included angle α is preferably one to two degrees less than the adjacent angle β of the ring teeth. The side of the center tooth facing the loaded pawl teeth is adjusted in this step as a non-loaded side. The load-bearing sides 112 of the pawl teeth are not adjusted. Thus, except for the pivot tooth, the load-bearing sides of the pawl teeth are slightly out of flush with their opposing ring tooth sides.

This defines the dimensions of the ring teeth on one side of the pawl. The teeth on the other pawl side are then adjusted to be the mirror image (across the pawl's center line) of the first side. The pawl (and ring) teeth are rounded as desired, and the rounded tips preferably remain on a common arc. As discussed above, the definition of a ratio between the ring radius and the pawl radius that is less than 1:1 (i.e., the ring radius is less than the pawl radius) facilitates the pawl's removal from the ring when wrench transitions from applying force to a workpiece to ratcheting.

A pawl constructed as described above may be used in reversible ratcheting wrenches. However, these pawls may also be used in the nonreversible wrench of the present invention. As described above with reference to FIGS. 1-4, pawl 44 is wedge shaped so that the pawl fits in compartment 18 between compartment wall 20 and toothed ring 30. To form a pawl that functions similar to pawl 44 (FIG. 2), pawl 100 (FIGS. 5 and 5B) may be cut in half either at center tooth 118 or though a center trough if there is an even number of teeth across the face of pawl 100. Thus, the manufacture of a single pawl 100 results in two pawls each for use in a separate wrench. Because a single pawl satisfies the pawl requirements of two wrenches, a pawl manufactured as described in FIGS. 5-5B can double pawl production for reversible wrenches without having to run a separate manufacturing station for nonreversible wrench pawls.

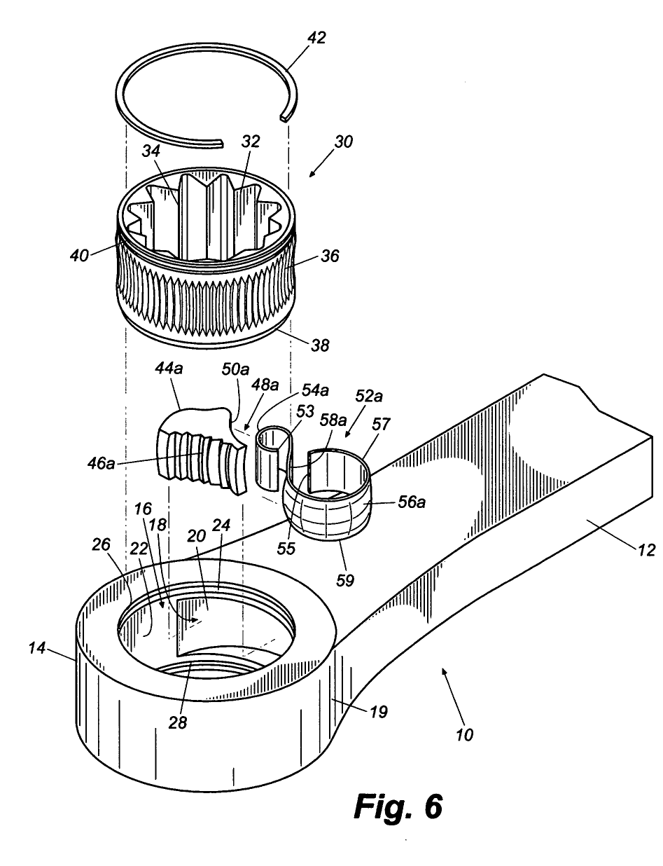

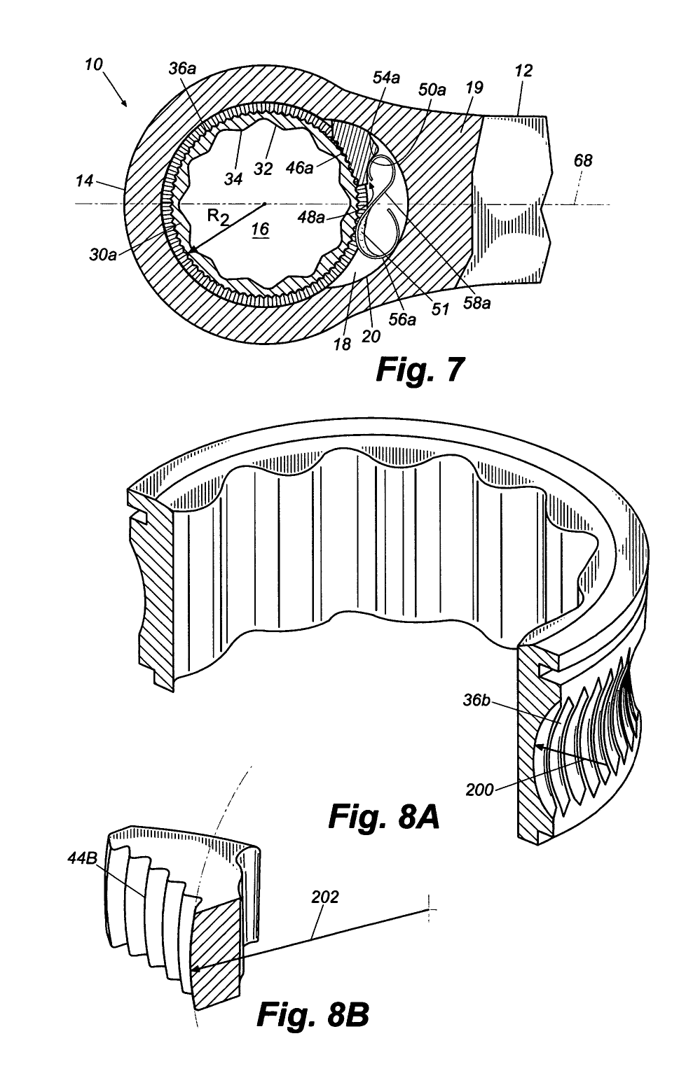

Referring to FIGS. 6-7, a ratcheting tool 10 has the same features of the wrench shown in FIGS. 1-4 except for an alternate pawl (one-half of pawl 100, FIGS. 5 and 5B), toothed ring and spring design. Thus, similar parts of the wrench shown in FIGS. 6-7 are indicated by the same reference numerals used in FIGS. 1-4, and an “a” has been added to reference numerals for parts that have changed to accommodate the pawl having a radius that differs from the radius of the toothed ring.

Referring to FIG. 6, wrench 10 includes a body with a handle 12 and a head 14 extending from one end of the handle. The head and handle may be integrally formed from a material capable of withstanding high shear forces, for example stainless steel, metal alloys, ceramics, or polymers. Handle 12 may be a solid piece and is generally rectangular in shape. The shape and length of handle 12 may vary depending on the application of ratcheting tool 10; for example, handle 12 may be generally cylindrical or polygonal in cross-section. An open end head or box end head may be formed on the end of handle 12 opposite from head 14, as should be well understood in the art.

Head 14 defines a relatively large and generally cylindrically shaped through-hole compartment 16. A smaller compartment 18 defined in a web portion 20 is intermediate compartment 16 and handle 12, closed above and below and in communication with compartment 16. Compartment 18 is generally wedge shaped and bounded by a curved side wall 20. A wall 22 defining compartment 16 also defines an annular groove 24 proximate its top edge 26 and a flat annular inward extending ledge 28 proximate its bottom edge.

Compartment 16 receives an annular toothed ring 30a having an inner surface 32 that is concentric with wall 22. Inner ring surface 32 defines a plurality of aligned keys 34 spaced equiangularly about inner surface 32. Keys 34 extend radially into compartment 16 and are spaced to engage the sides of a bolt, nut, or other work piece. The outer circumference of toothed ring 30a defines a series of vertically-aligned teeth 36a. Teeth 36a curve inward at their center so that the toothed ring's outer surface defines a concave shape. Toothed ring 30a has a radius R2 (FIG. 7) measured from its center to the troughs of teeth 36a.

A bottom side of toothed ring 30a defines an extension portion 38 surrounded by a flat annular shoulder (not shown). Extension portion 38 fits through ledge 28 so that the shoulder sits on ledge 28, thereby retaining toothed ring 30a in the lower axial direction. Extension portion 38 fits through ledge 28 with sufficient clearance so that the ledge secures the toothed ring in the radial direction yet permits the toothed ring to rotate with respect to head 14. Toothed ring 30a defines an annular groove 40 about its outer surface proximate its upper end. A C-ring 42 is received in groove 40, and an outer surface of the ring normally extends slightly outward of the groove. As toothed ring 30a is inserted into compartment 16, C-ring 48 compresses into groove 40 until groove 40 aligns with annular groove 24 in the upper edge of wall 22. C-ring 42 then expands into groove 40, thereby securing toothed ring 30a in the upper axial direction.

A generally wedge-shaped pawl 44a is received in compartment 18 so that the top and bottom surfaces of compartment 18 retain the pawl from above and below. Sufficient clearance is provided between those surfaces and the pawl, however, so that the pawl may easily slide from side to side. Pawl 44a defines a plurality of vertically-aligned teeth 46a in an arc across the pawl's front face having a radius R1 (not shown in the figure but shown in FIG. 5B) that is larger than the toothed ring radius R2 (FIG. 7). In the vertical direction, teeth 46a curve outward in a convex shape that corresponds to the concave outer surface of toothed ring 30a. The back end of pawl 44a defines a recessed portion 48a defined by a wall 50a. The relationship of R1 to R2 is described above in the discussion on designing pawl 100 and shown in FIGS. 5-5B.

A detent 52a (FIG. 6) is received in compartment 18 adjacent pawl 44a. Detent 52a is a generally S-shaped spring forming a first loop 54a and a larger second loop 56a interconnected by a main body 58a. The detent may be formed from any suitable resilient material, including stainless steel or metal alloys such as beryllium copper. The thickness of the detent material may vary by the wrench size and the amount of spring force required for biasing the pawl during operation of the wrench. In one embodiment, spring 52a is formed from a 0.010-0.012 of an inch thick spring stainless steel. A portion 51 (FIG. 7) of second loop 56a has a convex surface having a radius in the vertical plane that is approximately equal to the radius of curvature of ring teeth 36a. Thus, the vertical curvature of the spring that contacts toothed ring 30a is substantially similar to that of the toothed ring so that the spring does not bind with the ring teeth.

Referring to FIG. 7, spring 52a is sized and shaped to maintain pawl 44a in contact with toothed ring 30a. That is, first loop 54a is received in pawl recess 48a adjacent to pawl wall 50a. Spring second loop 56a is received intermediate toothed ring 30a and pawl compartment wall 20 so that curved portion 51 is received by concave ring teeth 36a. In this position, spring 52 maintains pawl 44a in a wedged position between ring teeth 36a and pawl compartment wall 20. Because of the size and shape of spring 52a, pawl 44a is maintained in the wedged position under minimal spring tension.

In operation, pawl 44a may slide over a limited distance in compartment 18 against the bias of spring 52a. In one position shown in FIG. 7, pawl 44a is wedged between toothed ring 30a and compartment wall 20. First loop 54a of spring 52a engages recessed wall 50a of pawl 44a so that the spring maintains the pawl in a position at which pawl teeth 46a align with and engage ring teeth 36a. The pawl end proximate wall 20 abuts the wall so that the pawl wedges between the wall and the ring. Thus, if torque is applied to handle 12 in the clockwise direction (as viewed in FIG. 7), pawl compartment wall 20 pushes pawl teeth 46a against ring teeth 36a. As a result, the pawl remains wedged between the toothed ring and the compartment's top edge, and the force applied from the operator's hand to the pawl through pawl compartment wall 20 is applied in the clockwise direction to a work piece through toothed ring 30a.

Alternatively, if an operator applies torque to the handle in the counterclockwise direction (as viewed in FIG. 3), ring teeth 36a apply a clockwise reaction force to pawl teeth 46a. If toothed ring 30a remains rotationally fixed to the work piece and the reaction force is reversed, the pawl moves back and down into compartment 18 against the force of spring 52a, causing recessed wall 50a to push against spring first loop 54a. This forces first loop 54a toward second loop 56a against the spring's natural bias so that pawl teeth 46a eventually ride over ring teeth 36a. After the pawl teeth ride over the ring teeth, spring 52a once again pushes against pawl recessed wall 50a so that pawl 44a moves back up pawl compartment wall 20 and into the next set of ring teeth. This ratcheting process repeats as the operator continues to rotate handle 12 in the clockwise direction. As explained with reference to the ratcheting tool of FIGS. 1-4, to change the operative direction of ratcheting tool 10, the operator flips the wrench 180 degrees about an axis 68 of the wrench. Thus, the operation of the wrench is the same as explained above, but the wrench applies force and ratchets in the opposite directions.

In the wrench embodiment shown in FIGS. 6-7, the ring and pawl teeth do not extend straight from the top to the bottom of the ring and pawl. That is, the ring's outer surface is concave, and the ring teeth extend vertically between the top and bottom of the ring in an inward curve. Correspondingly, the figures illustrate the ring teeth curving outward toward the ring's top and bottom edges. In this configuration, the pawl face is formed in a correspondingly convex shape so that the pawl teeth extend between the top and bottom of the pawl in an outward curve to interengage with the ring teeth.

Referring particularly to FIGS. 8A and 8B, a radius 200 of the arc extending between opposite axial edges of the ring and defined by the troughs between concave vertical ring teeth 36b may be equal to a radius 202 of the arc extending between top and bottom sides of the pawl face and defined by the edges of convex vertical pawl teeth 44b. However, to allow for the effects of manufacturing tolerances in the alignment of the vertical teeth on the ring and the pawl, and of twisting deformation of the ring under high torque loads, the pawl's convex radius 202 is preferably less than the ring's concave radius 200.

In an embodiment of a three-quarter inch ratchet wrench, for example, concave ring radius 200 is 0.236 inches, while convex pawl radius 202 is 0.200 inches. This arrangement permits effective operation of the wrench even if the ring and/or pawl teeth are as much as 0.020 inches out of vertical alignment. It should be understood that such a mismatch between the concave vertical ring radius and the convex vertical pawl radius may be practiced regardless of the relationship between the circumferential radii of the ring teeth and the pawl teeth. That is, the concave and convex radii may be different regardless whether the radius defined by an arc connecting the troughs of the ring teeth is equal to or different from the radius defined by an arc connecting the tips of the pawl teeth. Additionally, it should be understood that the concave and convex radii of the ring and the pawl, respectively, may be defined at any suitable position on the ring and the pawl that oppose each other when the pawl teeth engage the ring teeth. Thus, for example, the concave ring radius may be defined at the edge of the ring teeth while the convex pawl radius may be defined at the troughs between the pawl teeth.

The construction of the ratcheting tool may affect the extent or the desirability of a mismatch between the concave and convex radii of the ring and the pawl. For example, a toothed ring in a tool as shown in FIGS. 2 and 4, in which the ring is retained from the top by a ring, may be subject to greater misalignment than a ring retained from the top by the tool head itself because the latter construction exerts greater resistance against forces in the upward direction typically applied through the toothed ring when the tool is in use and provides smaller deviations from manufacturing tolerances. Accordingly, while a mismatch between the profile radii of the ring and the pawl may be employed in either arrangement, it is particularly desirable in a construction in which the ring is retained from the top by a retainer other than the wrench body, such as in the embodiment shown in FIGS. 2 and 4.

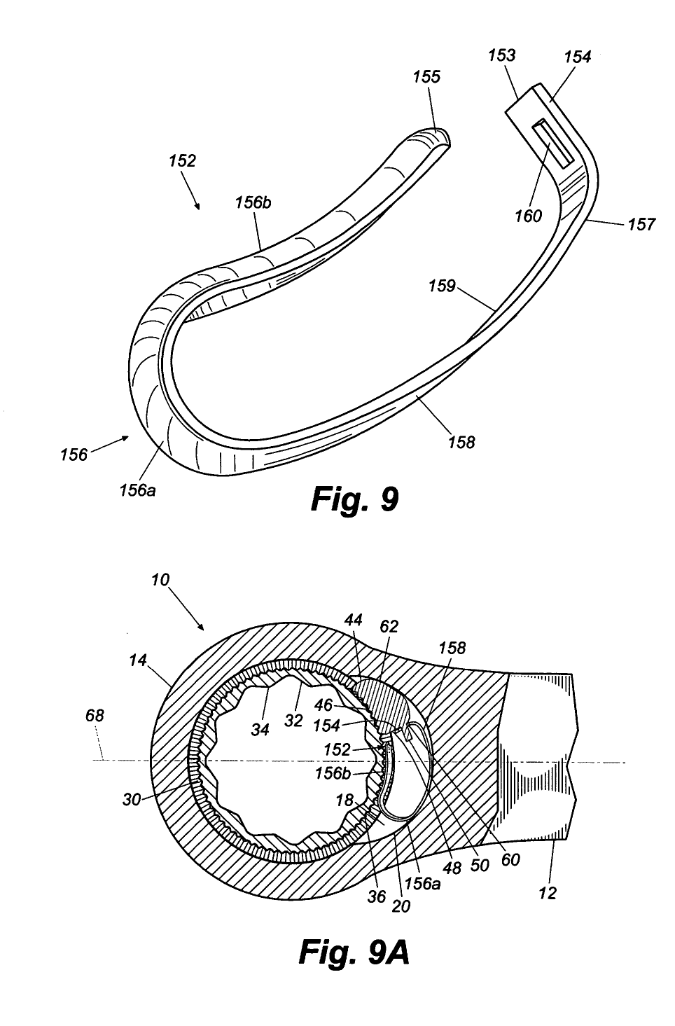

FIG. 9, referring to another embodiment of a spring for use in the ratcheting wrench of FIGS. 1-4 is illustrated. In particular, a spring 152 is formed from a spring material having a first end 153 and an opposite second end 155 that define a length therebetween that is substantially longer than a height between a top edge 157 and a bottom edge 159. Spring 152 defines a first straight end 154 and a curved second end 156 connected by a main body 158. Curved second end has a curved portion 156a and a second curved portion 156b that defines a double radii. That is, semi curved portion 156b is convex shaped in a plane perpendicular to top and bottom edge 157 and 158 and is also concave shaped in a horizontal plane that is parallel to top and bottom edge 157 and 158. The radius of curvature in the vertical direction is substantially similar to the vertical radius of curvature of ring teeth 36 to ensure that the spring does not bind with the ring teeth. Furthermore, the radii in both the vertical and horizontal planes maintains the spring in its position with respect to the pawl and the pawl compartment by being matingly received by toothed ring 30.

First straight end 154 defines an oblong shaped hole 160 that receives pawl projection 50 (FIG. 9A). The spring may be formed from any suitable resilient material, including stainless steel, nylon or metal alloys such as beryllium copper. The thickness of the spring material may vary by the wrench size and the amount of spring force required for biasing the pawl during operation of the wrench. In one embodiment, spring 152 is formed from a 0.010-0.012 inch thick stainless steel spring material.

Referring particularly to FIG. 9A, spring first end 154 is received adjacent to pawl end 48 so that pawl projection 50 is received in spring hole 160. Spring second end 156 is received intermediate toothed ring 30 and pawl compartment wall 20 so that curved portion 156a abuts pawl compartment wall 20 and spring semi curved portion 156b abuts with and is received against concave teeth 36. Spring second end 55 is slightly curved away from toothed ring 30 to ensure that the spring does not bind with the ring teeth during operation of the wrench. In the position shown in FIG. 9A, pawl 44 is wedged between toothed ring 30 and pawl compartment wall 20 under minimum tension by spring 52. That is, spring 52 maintains pawl 44 in contact with ring 30 so that the pawl teeth are in meshing engagement with the ring teeth. Thus, if torque is applied to handle 12 in the clockwise direction (as viewed in FIG. 9A), pawl compartment wall 20 pushes pawl teeth 46 against ring teeth 36. As a result, the pawl remains wedged between the toothed ring and the compartment's wall, and the force applied from the operator's hand to the pawl through pawl compartment wall 20 is applied in the clockwise direction to a work piece through toothed ring 30. Alternatively, if an operator applies torque to the handle in the counterclockwise direction (as viewed in FIG. 9A), ring teeth 36 apply a clockwise reaction force to pawl teeth 46 and the pawl moves back and down into compartment 18 forcing spring first end 154 toward spring second end 156 against the spring's natural bias so that pawl teeth 46 eventually ride over ring teeth 36. After the pawl teeth ride over the ring teeth, spring 152 once again pushes against pawl end 48 so that pawl 44 moves back up pawl compartment wall 20 and into the next set of ring teeth. This ratcheting process repeats as the operator continues to rotate handle 12 in the clockwise direction.

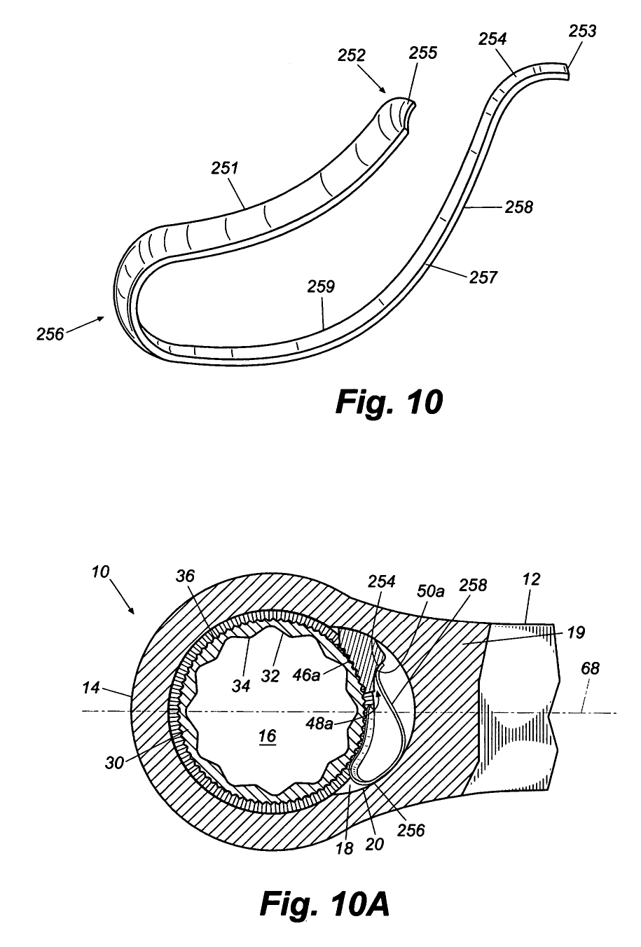

FIG. 10, illustrates yet another embodiment of a spring for use in the ratcheting wrench of FIGS. 6-7. In particular, a spring 252 has a first end 253 and a second end 255. A first curved portion 254 is formed proximate spring first end 253 and a second curved portion 256 is formed a intermediate spring first end 253 and spring second end 255. Intermediate spring second curve portion 256 and spring second end 255 is a double radii portion 251. In particular, spring portion 251 has a vertical radius forming a convex portion in a planes perpendicular to top edge 257 and bottom edge 259 of spring 252.

That is approximately equal to the radius of curvature of ring teeth 36a. Double radii portion 257 is also curved in a plane perpendicular to the vertical plane such that double radii portion 251 forms a concave curve that substantially matches the radius of curvature of ring 30. The detent may be formed from any suitable resilient material, including stainless steel or metal alloys such as beryllium copper. The thickness of the detent material may vary by the wrench size and the amount of spring force required for biasing the pawl during operation of the wrench. In one embodiment, spring 252 is formed from a 0.010-0.012 of an inch thick spring stainless steel.

Referring to FIG. 10A, spring 252 is sized and shaped to maintain pawl 44a in contact with toothed ring 30a. That is, first curved portion 254 is received in pawl recess 48a adjacent to pawl wall 50a. Spring second curved portion 256 is received intermediate toothed ring 30a and pawl compartment wall 20 so that double radii portion 251 is received by concave ring teeth 36a. In this position, spring 252 maintains pawl 44a in a wedged position between ring teeth 36a and pawl compartment wall 20. Because of the size and shape of spring 252, pawl 44a is maintained in the wedged position under very little spring tension.

In operation, pawl 44a may slide over a limited distance in compartment 18 against the bias of spring 252. In one position shown in FIG. 10A, pawl 44a is wedged between toothed ring 30a and compartment wall 20. First curved portion 254 of spring 252 engages recessed wall 50a of pawl 44a so that the spring maintains the pawl in a position at which pawl teeth 46a align with and engage ring teeth 36a. The pawl end proximate wall 20 abuts the wall so that the pawl wedges between the wall and the ring. Thus, if torque is applied to handle 12 in the clockwise direction (as viewed in FIG. 10A), pawl compartment wall 20 pushes pawl teeth 46a against ring teeth 36a. As a result, the pawl remains wedged between the toothed ring and the compartment's top edge, and the force applied from the operator's hand to the pawl through pawl compartment wall 20 is applied in the clockwise direction to a work piece through toothed ring 30a.

Alternatively, if an operator applies torque to the handle in the counterclockwise direction (as viewed in FIG. 10A), ring teeth 36a apply a clockwise reaction force to pawl teeth 46a. If toothed ring 30a remains rotationally fixed to the work piece and the reaction force is reversed, the pawl moves back and down into compartment 18 against the force of spring 252, causing recessed wall 50a to push against spring first curved portion 254. This forces first curved portion 254 toward second curved portion 256 against the spring's natural bias so that pawl teeth 46a eventually ride over ring teeth 36a. After the pawl teeth ride over the ring teeth, spring 252 once again pushes against pawl recessed wall 50a so that pawl 44a moves back up pawl compartment wall 20 and into the next set of ring teeth. This ratcheting process repeats as the operator continues to rotate handle 12 in the clockwise direction. As explained with reference to the ratcheting tool of FIGS. 1-4, to change the operative direction of ratcheting tool 10, the operator flips the wrench 180 degrees about an axis 68 of the wrench. Thus, the operation of the wrench is the same as explained above, but the wrench applies force and ratchets in the opposite directions.

It should be appreciated by those skilled in the art that various modifications and variations can be made in the present invention without departing from the scope and spirit of the invention. For example, pawl teeth having a differing radius than the gear teeth may also be employed in the embodiment shown in FIGS. 1-4 and 9. Moreover, the pawl and gear teeth may be made such that they are planar in the vertical direction such that neither contains a concave or convex arc. It is intended that the present invention cover such modifications and variations as come within the scope and spirit of the appended claims and their equivalents.

What is claimed:

1. A ratcheting tool comprising:
a. a body;
b. a ring rotatably disposed in said body and defining a plurality of teeth about an outer circumference thereof;
c. a pawl disposed in said body and having
a front side that faces said plurality of ring teeth and that has a plurality of teeth thereon,
a back side facing away from said ring, and
a projection extending from a portion of said pawl intermediate said pawl front side and said pawl back side,
wherein said pawl is movable between a first position in which said body imparts rotation to said ring in a first direction and a second position in which said body rotates relative to said ring in a second direction opposite said first direction; and
d. a spring disposed in said body and in operative engagement with said pawl so that said spring biases said pawl into said first position, said spring having,
flat first end in operative engagement with said pawl projection,
a curved second end intermediate said body and said ring, and
a main body connecting said flat first end and said curved second end,
wherein said spring main body biases said flat first end away from said curved second end.

2. The ratcheting tool of claim 1, wherein said pawl teeth are defined across a first radius and wherein said ring teeth are defined across a second radius that is smaller than said first radius.

3. The ratcheting tool of claim 1, wherein said detent flat first end defines an oblong hole therethrough that receives said pawl projection.

4. The ratcheting tool of claim 3, wherein a length of said flat first end oblong hole is larger than a diameter of said pawl projection so that said pawl projection can traverse said oblong hole.

5. A ratcheting tool comprising:
a. a body;
b. a ring rotatably disposed in said body and defining a first plurality of teeth about an outer circumference thereof;
c. a pawl disposed in said body and having
a front side that faces said first plurality of ring teeth and that has a second plurality of teeth thereon, and
a back side facing away from said ring and defining a recessed area, wherein said pawl is movable between a first position in which said body imparts rotation to said ring in a first direction and a second position in which said body rotates relative to said ring in a second direction opposite said first direction; and
d. a detent disposed in said body and in operative engagement with said pawl so that said detent biases said pawl into said first and said second positions, said detent having,
a first looped portion received by said pawl recessed area, and
a second looped portion that is continuous with said first looped portion and of a larger cross-section than said first looped portion wherein said second larger looped portion is received intermediate said body and said ring.

6. The ratcheting tool of claim 5, wherein said pawl teeth are defined across a first radius and wherein said ring teeth are defined across a second radius that is smaller than said first radius.

7. A ratcheting tool comprising:
a. a body;
b. a ring rotatably disposed in said body and defining a first plurality of teeth about an outer circumference thereof;
c. a pawl disposed in said body and having
a front side that faces said first plurality of ring teeth and that has a second plurality of teeth thereon, and
a back side facing away from said ring, wherein said pawl is movable between a first position in which said body imparts rotation to said ring in a first direction and a second position in which said body rotates relative to said ring in a second direction opposite said first direction; and
d. a detent disposed in said body and in operative engagement with said pawl, said detent being formed from a flat spring material having
a first end and an opposite second end,
a top edge and a bottom edge that extend between said first end and said opposite second end, and
a thickness between a front face and a back face of said flat spring,
wherein said length is larger than both of said height and said thickness, and wherein said flat spring has at least one bend transverse to said length that bisects said flat spring into a first portion and a second portion, and
wherein said first spring portion engages said pawl and said second spring portion is intermediate said body and said ring.

8. The ratchet tool of claim 7, wherein said detent is formed from a nylon material.

9. The ratchet tool of claim 7, wherein said detent is formed from a metallic material.

10. The ratcheting tool of claim 7, wherein said pawl teeth are formed about a first radius and wherein said ring teeth are defined about a second radius that is smaller than said first radius.
